(19) United States
(12) Patent Application Publication
(10) Pub. No.: US 2020/0215794 A1
(43) Pub. Date: Jul. 9, 2020

(54) FOIL WITH EMBOSSING FOR CLOSING CONTAINERS BY MEANS OF SEALING

(71) Applicant: Constantia Teich GmbH, Weinburg (AT)

(72) Inventor: Franz PLANER, Weinburg (AT)

(21) Appl. No.: 16/623,739

(22) PCT Filed: Jun. 20, 2017
(86) PCT No.: PCT/EP2017/065055

§ 371 Date: Dec. 17, 2019

(51) Int. Cl. B32B 15/08; B32B 15/20

(52) U.S. Cl. CPC B32B 15/08; B32B 38/06; B32B 15/20

(57) ABSTRACT

Foil having an embossing, including at least one aluminum foil with at least one layer made of a sealing material, for closing containers. In order to prevent blocking, the embossing has longitudinally convex, preferably approximately elliptical depressions of an invariably equal size and shape, arranged in an orderly pattern.

The invention relates to a foil having an embossing for closing containers by sealing with an aluminum foil and at least one applied sealing layer on the side later facing the contents; according to the preamble of claim 1. Depending on the application, other layers are easily provided, such as a layer of primer between the aluminum and the sealing layer, multilayer sealing layers and a variety of other designs with, as an example for the later outer side, a primer layer, a printing layer and a pressure protection layer, depending on the application.

Such foils are produced by coextrusion or lamination, and the application by painting individual layers onto the aluminum or the production of corresponding intermediate layers of the final product is also possible. After production of the blank present in the form of a continuous tape, the foils are punched out, stacked, and transported to the filler. In the filling machine, the uppermost foil of the stack is lifted from the same by a device provided with a suction device, placed on the already filled container and then sealed to the container by use of pressure and heat. It is important that no so-called blocking occurs between the individual foils, which is inevitable for smooth foils due to the close contact and the external air pressure.

Various measures are known to prevent blocking, such as the application of small-scale elevations on the sealing layer, more rarely on the outside, or most commonly the embossing of the entire surface of the foil to avoid a smooth surface and thus flat abutment for the prevention of blocking.

All previously known embossing patterns are stochastically constructed; known are the so-called “worm pattern” and checks, wherein for the checks the intersecting lines are indeed straight but never parallel or in right angles to one another. This is necessary to reliably avoid cases in which the embossings coincide at least in certain areas and thus may slide into each other within the stack, which in turn leads to blocking, even if not the entire surface but only one small area of the foil is affected.

Such stochastic embossings, which are called “asymmetric embossings” in the industry, are inexpensive to manufacture and fulfill their purpose, but they have a negative effect on the visual appearance of the printed image on the outside, and thus there is a need for an embossing which allows for a visually more appealing appearance of the printed image on the outside without compromising the merits of the known embossings.

The object of the invention is to provide such an embossing.

According to the invention, this object and more is achieved by the measures and characteristics specified in the characterizing part of claim 1; in other words, an embossing is used in which the foil material is embossed with approximately elliptical depressions of the same size and shape and optionally the same orientation in one ordered patterns, thus creating a so-called “symmetric” embossing.

In a completely unexpected way, in such an embossing, in which the area of the approximately elliptical markings is at least 20%, preferably at least 35% and more preferably at least 50% of the total area (always viewed and measured in projection onto the central film plane), [the markings] are formed sufficiently different due to the evidently unavoidable tolerances encountered during the embossing process, so that they are unable to slip into one another, by which blocking is reliably avoided.

In the application and the claims, “approximately elliptical”, subsequently more appropriately and generally called “longitudinally convex”, is understood to be not only a strictly elliptical area, but also an area composed of several three-centered arches, but also other forms of areas, such as a rounded longitudinal rectangle, or even such areas with a contour featuring small-scale teeth at the edge when compared to the surface of the recess (which may also be rounded, or waves, so that the term “convex” does not apply to these secondary elements), as long as the ratio of the longest axis to the “shortest” axis, which runs normal to the former and which in turn is the longest in that direction, is between 1.5:1 and 3.5:1.

If the outline of the recesses has secondary features, such as bulges or indentations, serrations or other deviations of a “smoothed” line, then the mentioned values and their ratios are easily determined by averaging and to be subsequently used.

It is also not necessary for the longitudinally convex surfaces to have one or more symmetry axes, although this is preferred because of the resulting particularly satisfactory optical appearance.

This document will subsequently refer to “recesses” and it is implied that the recesses are directed towards the later inside (the side with the sealing layer). This need not be, even if the obtained optics are slightly better that of “protrusions” or the imprint in both directions; it cannot be said why this is so, and it may also depend on the nature of the printed image on the outside. Therefore, the claims include all three possibilities: Recess towards the seal side, protrusion from the seal side and combinations thereof. Due to the fact that the film to be embossed comprises at least one aluminum foil with at least one sealing layer, the term “composite foil” is also sometimes used herein.

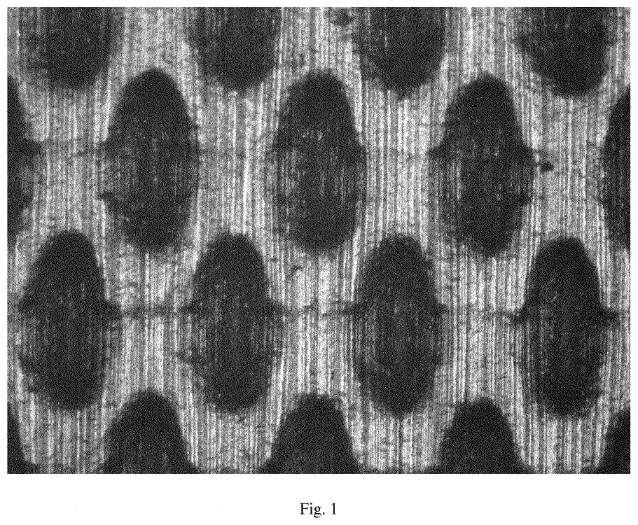

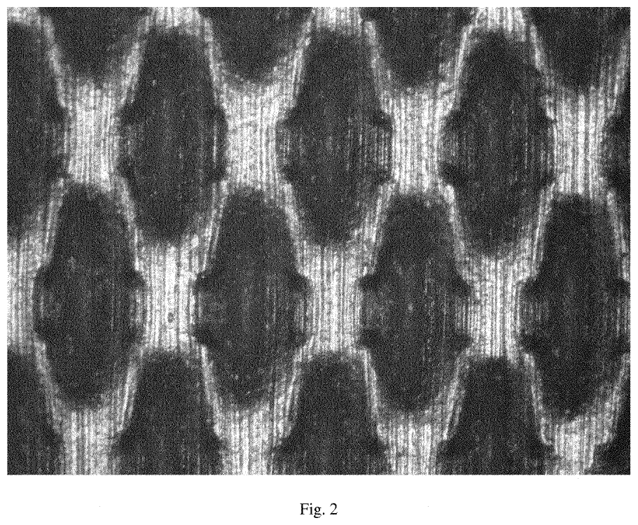

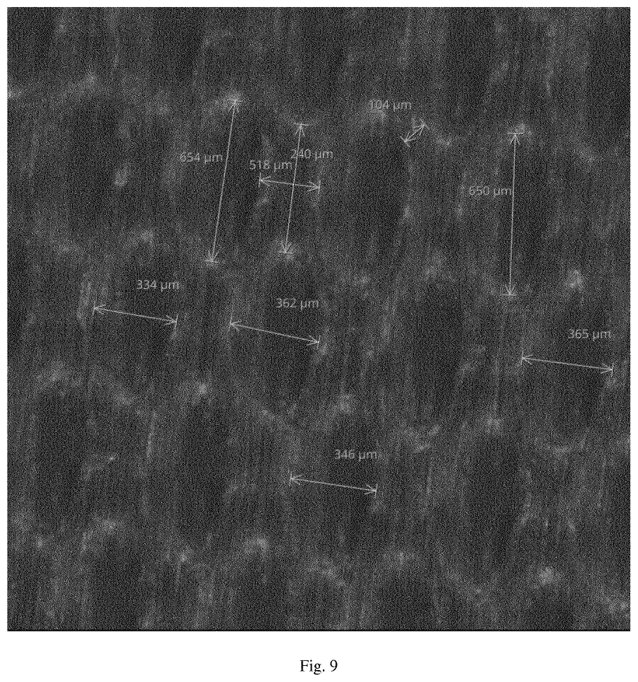

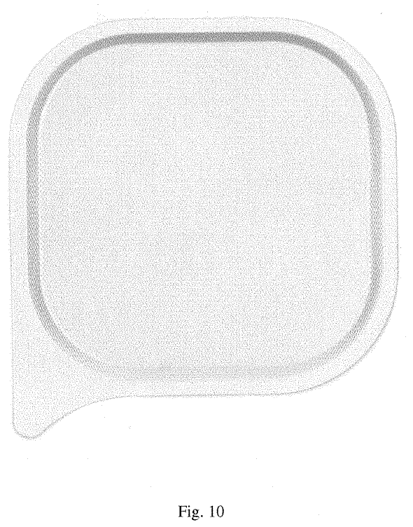

The invention will subsequently be explained in more detail with reference to an example and with reference to the drawing showing the exemplary embodiments. FIGS. 1 and 9 show different variants of films with different embossings according to the invention in different scales, partly measured, and FIG. 10 shows a scan of the inside of a foil according to the invention with the embossing of FIG. 2.

FIG. 1 shows a variant with recesses 1 with a shape which is very similar to an ellipse. The transition from the recesses 1 to the plane is relatively sharp; the length ratio of the radius is almost exactly 2:1; just over half of the total area (more precisely: in all cases: of the projection of the surface plane on the drawing plane) of the film is occupied by the recesses. The reference symbol “!” was been placed under one of the recesses located at the edge, because editing within the image was not possible.

FIG. 2 shows a similar film in which the recesses 1 have bulges 2 in the central longitudinal region (here as well, the reference symbols were placed in the lower margin as close as possible to the bulges) and the recesses constitute an even higher proportion of the film surface than in the example of FIG. 1. The ratio of the axial lengths, taking into account the bulges, is 7:4, thus 1.75:1. Without the bulges, it is 7:3, corresponding to 2.3:1.

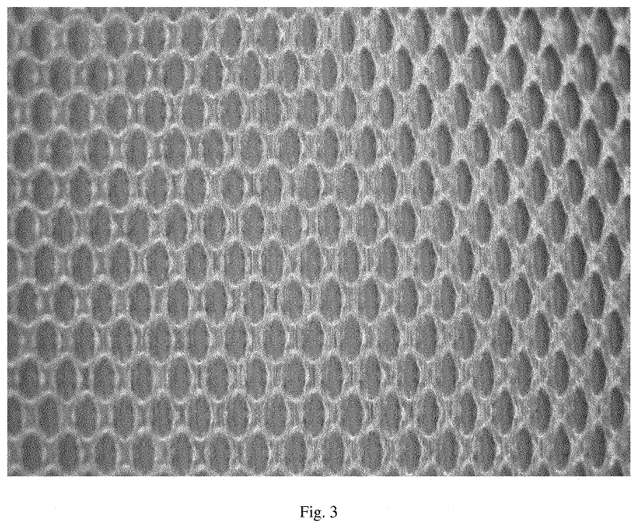

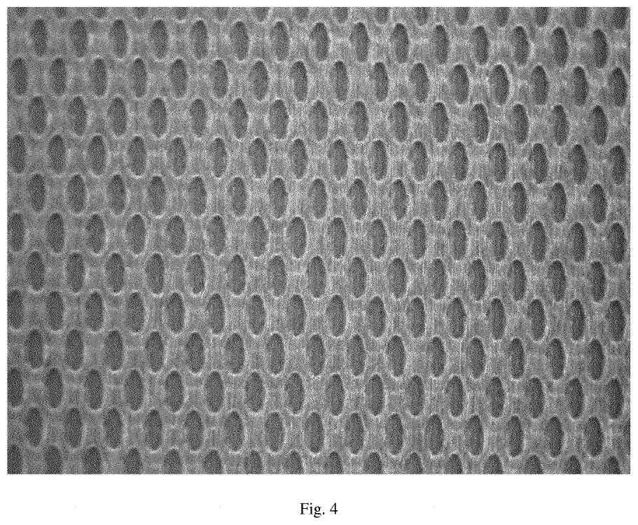

FIGS. 3 and 4 show the films of FIGS. 2 and 1 on a smaller scale; the differences across the surface are clearly visible in both cases and are due to the manual production of the embossing rollers. In addition to the formation of the recesses according to the invention, the manual production is probably an additional reason for preventing blocking.

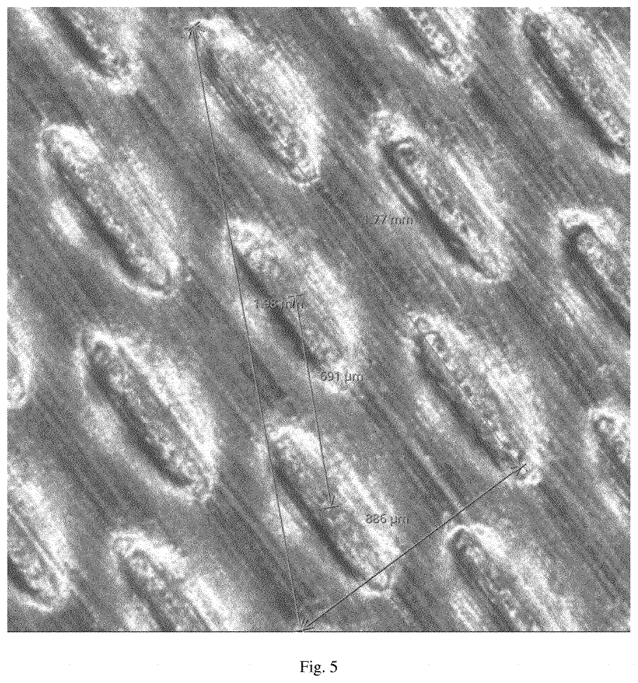

FIG. 5 shows several measurements, some in millimeters, some in micrometers: The distance from center to center of the recesses 1 in a “diagonal direction” is 691 μm; the distance between the rows is 886/2=443 μm, the distance drawn across two rows is 1.98 mm, and within the series with two recesses and a gap, it is 1.77 mm. Due of the differences in brightness, it is clearly visible that an approximately elliptical recess formed width-wise around the actual depression, which according to the invention is considered part of the depression, since it apparently contributes to the prevention of blocking. The geometry of FIG. 5 has about a 50% proportion of the area of the depressions.

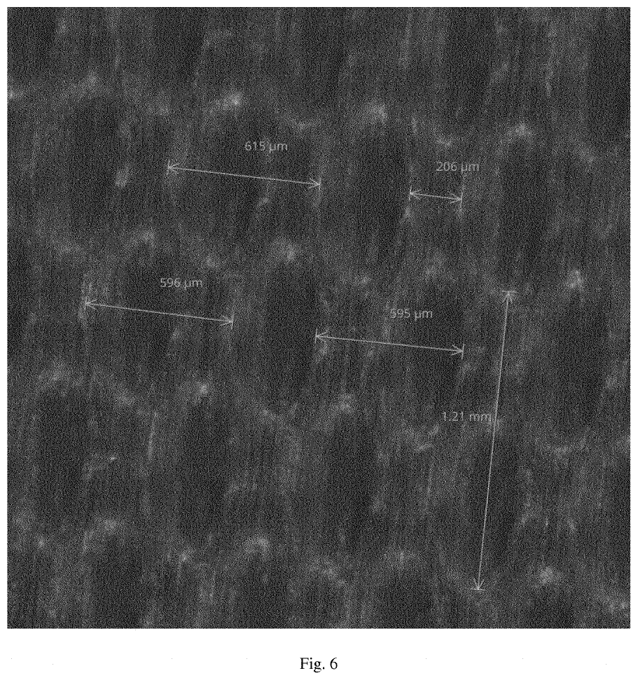

FIG. 6 shows a geometry in which the recesses transition much sharper into the plane, in comparison with those of FIG. 5, and in which they make up a much higher proportion of the total area; in some places there is almost contact between the recesses. In the longitudinal direction, the “period” is 1.21 mm, in the transverse direction, it is 595 or 596 or 615 μm; the transverse distance is about 206 μm. The shape of the recesses 1 is as close to an ellipse as the manual production method of the rollers [permits], both rolls are complementarily dressed and rotated in a strictly angular fashion, which is known in the art and permitted by the embossing process per se.

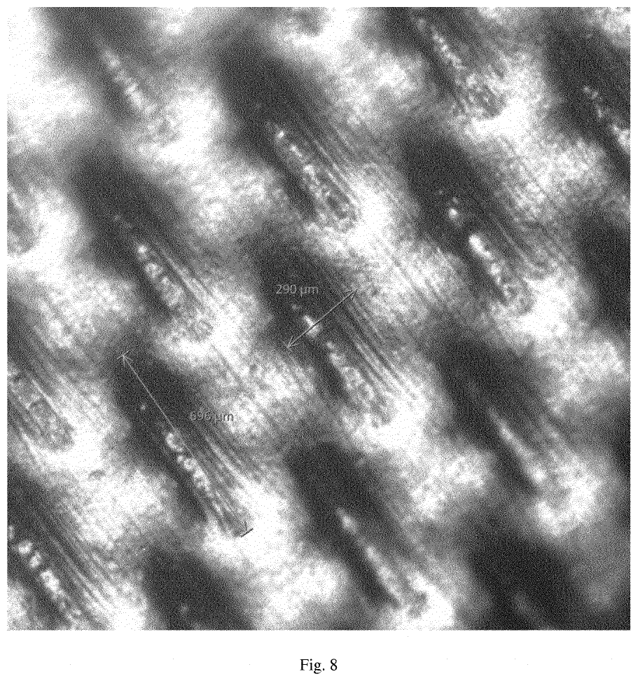

As can be seen from FIG. 8, a greatly (134×) enlarged image of a film formed according to the invention, the recesses 1 have a longitudinal dimension of 696 μm and at the widest point of 290 μm, the ratio thus being approximately 2.4. The shape of the recesses 1 is in its form in the core longitudinally rectangular with rounded ends, wherein the outer form is being brought into a longitudinally convex shape through impression in the central region in which the measurement is noted.

Whether this impression in the central region is a direct consequence of embossing or a side effect during the passage of the film through the pair of rollers, cannot be answered. As can be seen from the image, in the finished film, the definition of the boundaries of the recesses 1 is mathematically not entirely comprehensible, but by measuring several recesses useful averages can be obtained, which may also help to determine whether a present imprint falls within the scope or not.

As can be seen from the image, the recesses 1 are periodically arranged in rows one behind the other in the longitudinal direction, virtually in alignment, wherein adjacent rows are offset by approximately half the period length. This however is not necessary; even when offset by ⅓ of a period length, an optically satisfactory image with sufficient protection against blocking results; however, the distance between the rows greater than in FIG. 1 must be evidently selected to prevent the interlacing of the recesses 1.

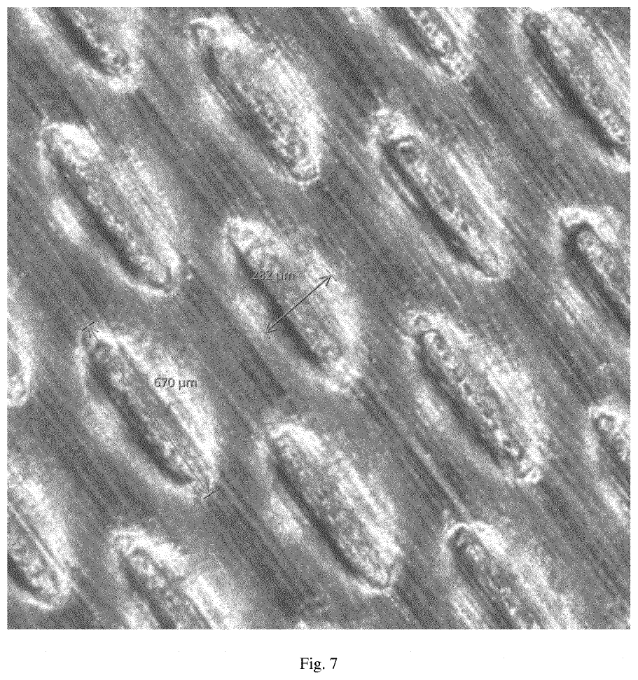

FIG. 7 shows a similar film as FIG. 8 with the same magnification, in which the recesses 1 have dimensions of 670 μm by 282 μm, corresponding to a ratio of 2.38:1. It can be clearly seen from FIG. 7 that at the ends, the transition from recess 1 to the “plane” is relatively sharp, while width-wise a kind of “halo” (bulge) forms and the transition to the plane is not very pronounced. The area ratio of the recesses 1, including the bulges, is more than 50%.

FIG. 9 shows a geometry similar to that of FIG. 1; the lengths of the recesses vary between 650 and 654 μm, the widths between 334 and 365 μm, evidence for the bulges 2 in spite of the sharp transition (as compared to the geometry corresponding to FIG. 7).

The longitudinal distance is 518 μm, the transverse distance 240 μm, evidence of an area proportion of well over 50% for the recesses.

FIG. 10 shows the inside (provided with sealing material) of the embossing according to FIG. 2 as a scan, as it presents itself to the eye. The pleasant appearance is easily recognized.

It is apparent from the explanations of the Figures that, according to the manufacture of the molds and the embossing—which can never be carried out with mathematical precision —, even the stated dimensions are always to be determined only on average; this, however, is sufficient for the purpose of checking the fulfillment of the values stated in the Claims.

The thickness of the usable aluminum foils or aluminum-plastic composite foils is not critical; the thicknesses used in the prior art for foils can also be used in the embossing according to the invention. Thus, the thickness of the composite film before embossing, which remains practically unchanged between the recesses even after embossing, is usually 30 μm to 100 μm, preferably between 50 μm and 70 μm. Naturally, the chosen thickness depends not only on the intended use of the finished foil, but also on its structure, as is known to the person skilled in the art. Whether so-called “soft” or “hard” aluminum or whichever of the conventional alloys, which in the packaging industry are generally simply referred to as “aluminum”, is used, also depends on the field of application.

The depth of the recesses is between 0.1 times, preferably 0.5 times and 2.0 times, in special cases also more than that, of the thickness of the considered composite film (foil) before embossing.

All known materials can be used as sealing materials, including PP as well as others; the application can be done by coextrusion, laminating but also by printing or painting. The other layers mentioned, as well as possibly further layers provided, affect neither the embossing nor the result and can therefore be provided or used as before.

It is only essential that the embossing has longitudinally convex, preferably approximately elliptical depressions of an invariably equal size and shape, arranged in an orderly pattern; that it optionally consists of several of a multitude of such recesses which differ from one another; optionally after smoothing the outline. In this case, to name just one example, smaller and larger recesses may be arranged in the manner of a checkerboard pattern, but it is also possible to provide more than two different configurations. It has already been mentioned that the embossing usually covers the composite film completely, but this is not a necessity.

### LIST OF REFERENCE NUMBERS

01 Recess(es)
02 Bulge(s)

1. A foil for closing containers having an embossing, comprising at least one aluminum foil with at least one layer made of a sealing material, wherein the embossing has longitudinally convex, preferably approximately elliptical recesses of an invariably equal size and shape, arranged in an orderly pattern on a surface of the foil.

2. The foil according to claim 1, wherein a ratio of the largest length (L) of the recesses to a largest normally measured width (B) is between 1.5:1 and 3.5:1.

3. The foil according to claim 1, wherein a surface of the recesses, measured in a projection onto a plane of the foil, is at least 20% of the foil surface.

4. The foil according to claim 1, wherein an outline of the recesses includes one or more secondary features.

5. The foil according to claim 1, wherein an embossing depth is between 0.1 times and 2.0 times of a thickness of the foil before embossing.

6. The foil according to claim 1, wherein a surface of the recesses, measured in a projection onto a plane of the foil, is at least 35% of the foil surface.

7. The foil according to claim 1, wherein the surface of the recesses, measured in a projection onto a plane of the foil, is at least 50% of the foil surface.

8. The foil according to claim 4, wherein the outline of the recesses includes one or more secondary features selected from the group consisting of bulges, indentations, teeth, and waves.
